(19) United States
(12) Patent Application Publication
(10) Pub. No.: US 2004/0210474 A1
(43) Pub. Date: Oct. 21, 2004

(54) User-configurable real-time drive-thru timing system

(76) Inventors: Charles Eric Hart, Acworth, GA (US); Johnny Hoyt Nix JR., Power Springs, GA (US)

Correspondence Address: William R. Silverio, SUTHERLAND ASBILL & BRENNAN LLP, 999 Peachtree Street, NE, Atlanta, GA, 30309-3996, US

(21) Appl. No.: 10/414,955

(22) Filed: Apr. 16, 2003

(51) Int. Cl. G06F 17/60

(52) U.S. Cl. 705/11

(57) ABSTRACT

User-configurable drive-thru timing system that monitors performance and generates real-time messages and reports in real-time. System monitors vehicles in a drive-thru and the displays to drive-thru employees user-configurable text and information, such as user-selected timing information or whether employees are meeting, or failing to meet, user-defined goals. Positive reinforcement that goals are being met encourages employees to provide fast and courteous drive-thru service. System allows the generation of reports in real-time, where the reports provide detailed information regarding the service provided to each vehicle. The system also communicates with other business computer components, such as POS terminals, which allows such systems to provide enhanced features relating to drive-thru service.

### FIELD OF THE INVENTION

The present invention relates to drive-thru timing systems, and more particularly, to a user-configurable drive-thru timing system that monitors drive-thru performance and generates user-configurable messages and reports in real-time.

### BACKGROUND OF THE INVENTION

Drive-thru service is now a common feature provided by businesses such as fast-food restaurants, banks, pharmacies, and dry-cleaners. The primary goal of the drive-thru is to provide a customer with fast and convenient service while simultaneously permitting the business to service a greater number of customers than is otherwise permissible through conventional walk-in transactions.

Based on the increasing number of drive-thru customers, it has become extremely important to ensure the efficiency of restaurant drive-thru service to guarantee that fast service is provided. In this regard, systems have been sought to improve the operating efficiency of the personnel associated with drive-thru businesses in order to reduce the delay between the time the vehicle is detected and the delivery of goods or services to the vehicle. For example, in the case of a drive-in bank, it is desirable to complete the banking transaction in a minimum amount of time following the arrival of the vehicle at the drive-in window in order to be able to serve as many customers as possible. Likewise, in the case of a drive-in restaurant, it is desirable to deliver the food order as quickly as possible following arrival of the vehicle at the pick-up window, again to be able to serve as many customers as possible, as well as to assure prompt delivery of hot food.

At least one prior art invention has attempted to provide a system to improve drive-thru performance of drive-thru employees through feedback instructing employees when customers have waited too long for drive-thru service. U.S. Pat. No. 4,392,119, to Price et al. (hereafter ‘Price’) describes an apparatus for timing drive-thru service to enable a business to improve drive-thru service. The invention described by Price senses the arrival of a motor vehicle at a pick-up window of a drive-thru business and provides a visual display of the length of time that motor vehicle is present at the window. Visual and audible alarms apprise drive-thru operating personnel that the vehicle has been present for a predetermined length of time selected by the operating personnel from a fixed set of times. The apparatus also totals and displays the number of vehicles as well as the total duration of stay of all vehicles arriving at the pick up window. Price also describes a display visible by all restaurant personnel showing the time that a particular car has been waiting at the window.

According to Price, an average service time per vehicle can also be calculated over the time period in which the system is turned on, though no display is provided for such information. In addition, Price also discloses the use of visible displays and audible alarms permit the employees of the business to work against specific time objectives, and consequently improve the speed and efficiency of the drive-thru operation. The invention disclosed by Price consequently provides store management with the capability to determine daily demand patterns and to detect trends; to isolate periods of efficient and inefficient operation; to quantify performance; and to warn supervisory, management and operation personnel that a vehicle has been waiting for longer than a predetermined time.

It will be appreciated that Price provides a useful timing tool to provide employees vehicle timing information that may be displayed to drive-thru employees, and an audible and visible alarm to identify when timing goals are exceeded. Price also provides numerical displays indicating the current vehicle time a vehicle has been waiting at a location, accumulated time of all vehicles at a station, and a total vehicle count of all vehicles using the drive-thru. However, Price does not provide a number of features that may be beneficial to both employees and management.

For instance, Price does not provide employees or management the ability to run user-configurable reports that provide details concerning the total elapsed time each vehicle waited in the drive-thru for a particular period of the day, or the average time each vehicle waited in the drive-thru for a user-defined period. Further, though Price provides a total vehicle count displayable to management personnel, Price does not provide a reporting system to provide drive-thru operators to evaluate the number of vehicles using the drive-thru for a user-selected time period. One reason Price is unable to provide such information is that the invention described by Price does not write real-time vehicle tracking data to a database which may be later searched based on user-configurable terms.

While Price also provides numerical displays indicating the length of time a vehicle has been at a transaction station, the total amount of times vehicles remain at a transaction station during the time the system remains on, and the total number of vehicles passing through the drive-thru, Price does not disclose or teach the use of one or more user-configurable graphical displays that provide employees a variety of information. For instance, Price does not provide user-configurable graphic displays can present user-selected vehicle tracking data, including total time a vehicle has remained in a drive-thru, the average time vehicles have taken to traverse the drive-thru, the time a vehicle has remained at a particular point in the drive-thru, the time it takes a drive-thru employee to take an order, and/or like timing information. Additionally, though Price can provide auditory or visual indications as to when a single, pre-set goal has not been met, Price fails to provide the user-configurable display of multiple messages related to a plurality of user-configured goals monitored by the system. For example, Price cannot display positive messages to employees which reinforce that the employees have met or exceeded goals. Moreover, the system provided by Price cannot monitor multiple goals, and provide messages which are determined based upon whether each of those respective goals is achieved or not met.

Price also fails to provide a simple means by which a user can configure multiple goals to be met by drive-thru employees. Price describes the program selection of a pre-established elapsed vehicle wait time, or goal, before a light and tone is provided to an employee. However, the selection is restricted to a single program selection hard-wired into the system. Therefore, Price fails to provide multiple user-configurable goals, including those that may be automatically established based on the time of day, thereby taking into consideration that drive-thru wait times and thus, employee performance, may vary based upon the time of day and likely volume of traffic in the drive-thru.

Other drive-thru timers, such as the “System 30” Timer provided by HM Electronics, Inc. and the “Fast Track 2+2 Timing Systems” (hereafter the ‘Fast Track System’) developed by Phase Research, provide enhanced vehicle tracking and the collection and grading of performance against predefined targets. In particular, the “System 30” timer allows a business to track service times to motivate employees and speed up operating efficiency. The “System 30” timer allows a business to pull special reports for major dayparts (i.e., portions of the day as broken up into single or multiple-hour segments), and to automatically collect timer data and generate reports to monitor drive-thru performance. The “System 30” timer also provides one or more 3 digit remote displays for presenting elapsed wait time to both employees and customers. The Fast Track System provides similar features as that provided by the “System 30” Timer, including the collection of data, the grading of performance against predefined targets, and the reporting of performance reports. The Fast Track System includes the ability to measure, store and display event times including greet delay at a menu board, total time at a menu board, time at the pay window, time at the pickup window, and overall time from arrival at the menu board to departure from the pickup window. Additionally, like the “System 30” timer, the Fast Track System provides one or two three-digit remote displays for illustrating elapsed time that a vehicle is in the drive-thru.

The “System 30” timer and the Fast Track System provide advantages over the system disclosed in Price, including the reporting of vehicle timing data and the establishment of multiple goals against which timing data can be compared. However, the “System 30” timer and Fast Track System fail to provide user-configurable displays to display user-configurable information, such as user-selected timing information or whether employees are meeting, or failing to meet, user-defined goals. Such information is critical to both inform employees of performance while boosting employee satisfaction through the display that goals are being met. Positive reinforcement that goals are being met encourages employees to provide fast and courteous drive-thru service. The “System 30” timer and Fast Track System also fail to integrate seamlessly with Point Of Sale (POS) terminals and other PC based products, as they typically provide only comma-separated streams of data that may be interpreted by proprietary hardware and/or software.

Therefore, what is needed is a drive-thru timing system that provides user-configurable displays, reports and goals to provide both management and employees with real-time and historical information detailing drive-thru performance without the limitations of the above systems.

### SUMMARY OF THE INVENTION

The present invention is directed generally to a sensing, monitoring and reporting system, and a method and computer program product, for use by a business having a drive-thru window. In particular, the present invention is a user-configurable drive-thru timing system that monitors performance and generates real-time messages and reports in real-time. The present invention provides user-configurable displays to display user-configurable text and information, such as user-selected timing information or whether employees are meeting, or failing to meet, user-defined goals. Such displays inform employees of performance while boosting employee satisfaction through the display that goals are being met. Positive reinforcement that goals are being met encourages employees to provide fast and courteous drive-thru service. The present invention also communicates with other business computer components, such as POS terminals, which allows such systems to provide enhanced features relating to drive-thru service.

According to one embodiment of the present invention, there is disclosed a user-configurable, real-time drive-thru system for analyzing and reporting the time to serve customers in a restaurant drive-thru having at least one vehicle detection device. The system includes at least one display, wherein the at least one display is viewable by an operator of the restaurant drive-thru, and a drive-thru timer, in communication with the at least one vehicle detection device, where the drive-thru timer collects vehicle event information, the vehicle event information based at least in part on the location of a vehicle in the restaurant drive-thru. The system also includes a control and reporting module, in communication with the drive-thru timer, where the control and reporting module is operable to receive the vehicle event information from the drive-thru timer, and where the control and reporting module is operable to receive at least one operator configurable message for subsequent display on the at least one display.

According to one aspect of the invention, the at least one operator configurable message consists of only letters. According to another aspect of the present invention, the control and reporting module is further operable to calculate, using the vehicle event information, the elapsed time the vehicle remains in the drive-thru. According to yet another aspect of the invention, the drive-thru timer is operable to receive the at least one operator configurable message from the control and reporting module, where the drive-thru timer displays the operator configurable message to the operator via the at least one display.

Furthermore, the control and reporting module is operable to receive at least one operator-configurable timing goal, and the drive-thru timer may receive the at least one operator-configurable goal from the control and reporting module. Additionally, in the system the at least one display is operable to display messages in at least two colors.

According to another aspect of the invention, the control and reporting module comprises a network interface, and the control and reporting module is remotely accessible via the network interface. The control and reporting module may also be in electrical communication with a point of sale (POS) terminal, and may include a user interface, the user interface operable to accept at least one goal input by the user.

According to another embodiment of the present invention, there is disclosed a method for displaying operator-configurable messages in a drive-thru system. The method includes the step of providing a drive-thru timer, in communication with at least one vehicle detection device, wherein the drive-thru timer collects vehicle event information based in part on the location of a vehicle in the restaurant drive-thru. The method also includes the step of displaying on at least one display, an operator-configurable message based at least in part on the vehicle event information.

According to one aspect of the present invention, the step of displaying the operator-configurable message includes displaying an operator-configurable message consisting of letters. According to another aspect of the invention, the method further includes providing a control and reporting module, where the control and reporting module receives the vehicle event information from the drive-thru timer, and where the control and reporting module receives the operator configurable message for display on the at least one display. According to yet another aspect of the invention, the method also includes the step of calculating vehicle timing data based on the vehicle event information, where the vehicle timing data comprises the elapsed time the vehicle remains in the drive-thru.

The drive-thru timer may also receive the operator configurable message from the control and reporting module, where the drive-thru timer displays the operator configurable message to the operator via the at least one display. Further, the control and reporting module may receive at least one operator-configurable timing goal and forward that at least one goal to the drive-thru timer. According to another aspect of the invention, the step of displaying on at least one display an operator-configurable message comprises the step of displaying the at least one operator-configurable message in at least two colors. Additionally, the method can further include accessing the control and reporting module remotely. Moreover, the control and reporting module may be in electrical communication with a point of sale (POS) terminal.

It will be appreciated that the apparatus and method of the present invention have specific application to restaurant-type businesses having a drive-in window where food orders may be placed and picked up without leaving a motor vehicle. Often such installations make use of a menu board or order station where the food order may be placed to be picked up at a subsequent pick-up window. While the present invention is described herein in connection with a drive-thru restaurant business, it will be appreciated by those of skill in the art that the present invention is applicable to any drive-thru business or service. Therefore, the present invention may be utilized by banks, pharmacies and other businesses in which customers can transact business without leaving their vehicles.

### BRIEF DESCRIPTION OF THE DRAWINGS

Having thus described the invention in general terms, reference will now be made to the accompanying drawings, which are not necessarily drawn to scale, and wherein:

FIG. 1 shows in block diagram form a real-time drive-thru timing system according to one embodiment of the present invention.

FIG. 2 shows a block diagram illustrating components comprising a real-time drive-thru timer of the real-time drive-thru timing system, according to one aspect of the present invention.

FIG. 3 shows a block diagram illustrating components comprising a control and reporting module of the real-time drive-thru timing system, according to one aspect of the present invention.

FIG. 4 shows an illustrative example of vehicle timing data for five vehicles generated by the control and reporting module based on vehicle event information received from the real-time drive-thru timer.

FIG. 5A shows a graphical entry interface for operating the control and reporting module, according to one aspect of the present invention.

FIG. 5B shows a graphical entry interface for operating the control and reporting module, according to another aspect of the present invention.

FIG. 6 shows a graphical log-on screen for logging into the control and reporting module, according to one aspect of the present invention.

FIG. 7 shows a graphical configuration interface for configuring the control and reporting module, according to one aspect of the present invention.

FIG. 8 shows a graphical goal entry interface for creating goals in the control and reporting module, according to one aspect of the present invention.

FIG. 9 shows a graphical user-configurable display interface for configuring messages to be displayed to a user by the real-time drive-thru timing system, according to one aspect of the present invention.

FIG. 10 shows a graphical reporting execution interface that enables a user to generate reports, according to one aspect of the present invention.

FIG. 11 shows a graphical report creation interface for creating reports, according to one aspect of the present invention.

FIG. 12 shows a graphical security interface which enables the creation of multiple access levels for using the control and reporting module, according to one aspect of the present invention.

FIG. 13 shows a report generated by the control and reporting module, according to one aspect of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention is described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto one or more general purpose computers, special purpose computers, or other programmable data processing apparatus to produce machines, such that the instructions which execute on the computers or other programmable data processing apparatus create means for implementing the functions specified in the flowchart block or blocks. Such computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks.

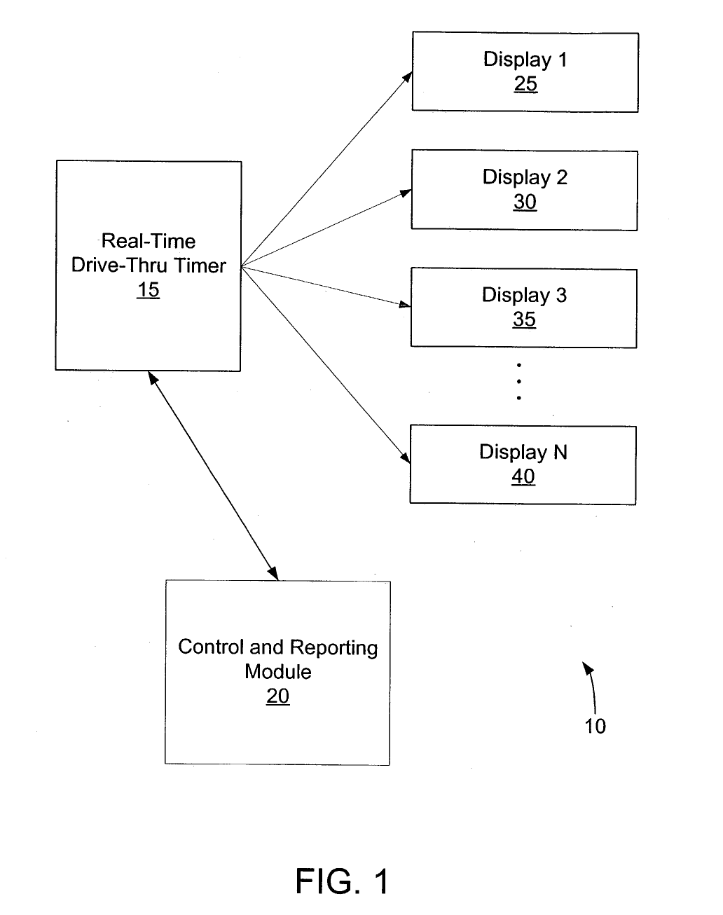

FIG. 1 shows in block diagram form a real-time drive-thru timing system 10 according to one embodiment of the present invention. The system 10 enables the real-time reporting of drive-thru vehicle timing data, the generation of reports based thereon, and the display of messages to drive-thru operators which enables operators to identify whether goals are being met in real-time. The system 10 includes a real-time drive-thru timer 15, a control and reporting module 20, and a plurality of displays 25, 30, 35, 40.

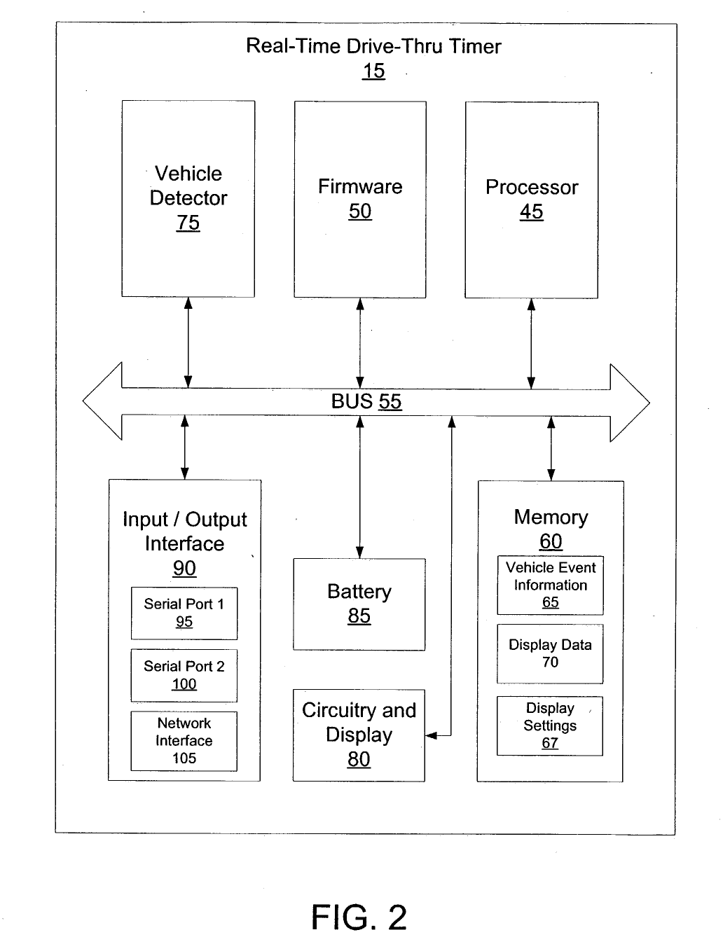

The real-time drive-thru timer 15, described in detail with respect to FIG. 2, is preferably in communication with at least two vehicle detection devices (not illustrated), respectively located at a restaurant's drive-thru speaker post (i.e., where drive-thru orders are placed by customers) and pickup window (i.e., where drive-thru orders are picked up). According to another aspect of the invention, additional vehicle detection devices may be placed at a pay window in businesses having separate pay and pickup windows, and at a pre-order location positioned in the drive-thru ahead of the speaker post. The vehicle detection devices, which are well known to those of ordinary skill in the art, communicate with the timer 15 to indicate the presence or absence of a vehicle.

The vehicle detection devices enable the real-time drive-thru timer 15 to monitor the location of vehicles in the drive-thru, the length of time each vehicle takes to pass through the drive-thru, or the time each vehicle spends at relative locations in the drive-thru, as will be explained in detail below. Upon collecting this information, referred to hereafter as vehicle event information, the real-time drive-thru timer 15 is operable to execute messages for display by the system 10 and to communicate the information in real time to the control and reporting module 20. The control and reporting module 20 manipulates the vehicle event information generated by the real-time drive-thru timer 15 to generate vehicle timing data, and enables operators to generate reports there from.

The real-time drive-thru timer 15 of the present invention uses past and present vehicle event information to execute real-time timing and performance messages displayed to the drive-thru operators through the plurality of displays 25, 30, 35, 40. For instance, the displays 25, 30, 35, 40 may indicate the length of time a vehicle has been in the drive-thru, a continuous daily average of the length of time it takes a vehicle to pass through the drive-thru, a length of time a vehicle remains at a particular location in the drive-thru, and similar service or wait time messages. The real-time drive-thru messages may also present one or more user-configurable messages on the displays 25, 30, 35, 40 to encourage employees or inform employees whether or not pre-established goals have or have not been met for vehicles having just been served, or are or aren't being met with the current drive-thru customer. As an illustrative example, where a vehicle spends very little time in the drive-thru such that the elapsed time the vehicle is in the drive-thru is less than a minimum time goal set by an operator of the system, one or more of the displays may indicate “Great Job” to the drive-thru employees.

The displays 25, 30, 35, 40 are preferably prominently displayed to all drive-thru operators so that the operators can view these performance and/or timing messages. The displays 25, 30, 35, 40 may be LCD displays, CRT displays, plasma displays, LED displays, or any other displays known in the art capable of displaying textual information. Additionally, as will be explained in greater detail below, it is preferable that the displays be capable of displaying textual information in multiple colors.

The real-time drive-thru-timer 15 communicates vehicle event information to the control and reporting module 20 in real time or near-real time. As explained in detail below, the vehicle event information is forwarded to the control and reporting module 20 either instantly, as it is received by the timer 15, or immediately after a vehicle departs the pickup window. Upon receiving the vehicle event information the control and reporting module 20 can generate vehicle timing data there from, and store the vehicle timing data in one or more databases. System operators can then use the control and reporting module 20 to review the vehicle event information and vehicle timing data determined there from to ascertain the performance of the drive-thru service. System operators can also manually or automatically create and view performance reports identifying the performance of the drive-thru, including the performance of the drive-thru in: servicing individual vehicles; servicing vehicles over a part of the day, referred to hereinafter as a ‘daypart’; servicing vehicles over an entire day; and servicing vehicles over time periods greater than 1 day. Additional reports may be run, as will be described in greater detail below.

As illustrated in FIG. 1, the real-time drive-thru timer 15 and control and reporting module 20 are in communication to effect the functions of the invention described herein. The devices are operable to communicate via a serial connection, as is well known in the art. Alternatively, this communication may also be effected over a network using TCP/IP, as is well known in the art. According to one aspect of the invention, the devices 15, 20 may communicate through respective wireless network interfaces such that the devices need not be hard wired, which is advantageous in installing the system in restaurants or businesses that are already constructed.

According to one embodiment of the present invention, the control and reporting module 20 is also in communication with additional business components such as Point-of-Sale (POS) terminals and Local Area Networks (LANs), though such is not illustrated in FIG. 1. The control and reporting module 20 may also be in communication with a Wide Area Network (WAN), including the Internet. Such a connection allows remote access to real-time data stored by the module 20. This enables a home office to monitor and generate real-time reports concerning the performance of remote branch location. This information may be used not only to determine the performance of an individual location, but to also assess how many vehicles pass through the drive-thru of at particular location. The components and function of real-time drive-thru timer 15 and control and reporting module 20 will next be described in greater detail with respect to FIGS. 2-4.

FIG. 2 shows a block diagram illustrating components comprising a real-time drive-thru timer 15 of the real-time drive-thru timing system 10, according to one aspect of the present invention. As illustrated in FIG. 2, the real-time drive-thru timer 15 generally comprises a processor 45, firmware/software 50, memory 60, vehicle detector inputs 75, battery 85, circuitry and display 80, and input/output interface 90. It should be appreciated that the components illustrated in FIG. 2 support combinations of means for performing the specified functions described herein. It will also be understood that each block of the block diagrams, and combinations of blocks in the block diagrams, can be implemented by special purpose hardware-based computer systems that perform the specified functions or steps, or combinations of special purpose hardware and computer instructions. Furthermore, each component, though illustrated individually, may be distributed in the real-time drive-thru timer 15 or combined with other components within the real-time drive-thru timer 15 to effect the functions described herein.

It will also be appreciated that the real-time drive-thru timer 15 may be embodied as a data processing system or a computer program product. Accordingly, the real-time drive-thru timer 15 may take the form of an entirely hardware embodiment, an entirely software embodiment or an embodiment combining software and hardware aspects. Furthermore, the real-time drive-thru timer 15 may take the form of a computer program product on a computer-readable storage medium having computer-readable program code means embodied in the storage medium. Any suitable computer-readable storage medium may be utilized including hard disks, CD-ROMs, DVDs, optical storage devices, or magnetic storage devices.

Referring again to FIG. 2, the processor 45 controls the operation of the real-time drive-thru timer 15 with the aid of firmware (and/or software) 50 which instructs the processor 45 how to execute the functions described herein. The processor 45 and firmware 50 communicate with the vehicle detector inputs 75, input/output interface 90, battery 85, circuitry and display 80, and memory 60 via the bus 55. The processor 45 and firmware 50 execute instructions to each component to effect the processes described hereafter. The vehicle detector inputs 75 communicates with conventional vehicle detection devices, or performs as a vehicle detection device. The memory 60 stores collected vehicle event information, display data and display setting information, respectively, in a vehicle event information database 65, a display data database 70, and display settings database 67. This information is used to generate the messages provided by the displays 25, 30, 35, 40. The battery 85 provides a backup power source, and the circuitry and display 80 provide indicators, viewable externally to the real-time drive-thru timer 15, concerning the status of vehicles at points in the drive-thru monitored by vehicle detection devices. Further, the input/output interface 90 includes a first serial port 95, for communicating with the control and reporting module 20, and a second serial port 100, for communicating with the displays 25, 30, 35, 40. The interface 90 also includes a network interface 105 for the timer 15 to communicate with the command and reporting module 20 where network communications using TCP/IP is preferred over serial communication.

Referring now in greater detail to the vehicle detector inputs 75, the detector 75 is configurable to detect the presence of vehicles at locations in the drive-thru, or to act as an interface and communicate with conventional vehicle detection devices previously installed in drive-thru systems. Where the vehicle detector inputs 75 acts as the vehicle detection system, rather than as an interface with such a system, it will be appreciated that some vehicle detector components will be located outside of the real-time drive-thru timer 15. Nevertheless, because the vehicle detector inputs 75 can communicate with conventional vehicle detection devices, which is a preferred embodiment, the system 10 of the present invention can be easily added to existing drive-thru systems 10. In the description below the vehicle detector inputs 75 acts as the interface between conventional vehicle detector devices and the real-time drive-thru timer 15.

A conventional vehicle detection device is a drive-thru loop, which is a coil of wire installed below the surface of the drive-thru. The coil is connected to a vehicle detect board (VDB) (not illustrated), which is connected to the vehicle detector inputs 75 of the real-time drive-thru timer 15. When a vehicle approaches a drive-thru speaker post, the vehicle will drive over the loop, which changes the electrical characteristics of the coil due to the metal in the vehicle. The change in the coil's electrical characteristics is sensed by the VDB, which then communicates to the real-time drive-thru timer 15, that a vehicle is present at the drive-thru speaker post. It will be appreciated by those of skill in the art that many restaurants use a VDB connected to a drive-thru loop to alert the restaurant that a customer is at the speaker post.

According to a preferred embodiment of the present invention, the vehicle detector inputs 75 is connected to drive-thru loops at both the drive-thru speaker post and the pickup window, so that the system can identify when a vehicle is present at each location. However, according to another aspect of the invention additional vehicle detection devices may also be located at other locations in the drive-thru, such as at pre-menu boards or cash windows (e.g., where the drive-thru includes both a pay window and a pick-up window). It will be appreciated, however, that these additional vehicle detection devices are unnecessary in enabling the system 10 to track the total time a vehicle spends in the drive-thru lane. Because the total time provides the most significant measurement of the time required to serve a customer the system 10 may be implemented without the additional vehicle detection devices. Nevertheless, these additional devices provide the system 10 the ability to track how much time each vehicle spends at each potential stopping point in a drive-thru system.

Signals reported by the vehicle detection devices via the vehicle detector inputs 75 thus enable the real-time drive-thru timing system 10 to determine when and where vehicles are located in the drive-thru to effect vehicle tracking, the display of drive-thru timing and performance information, and the generation of reports as described in detail hereinafter. Using this information the system 10 is further operable to identify when vehicles stop momentarily, for instance, at the speaker-post, and then drive away. To account for such ‘drive-offs’, using information provided by the vehicle detection devices the vehicle detector inputs 75 must register that a vehicle remains at the speaker post for at least, e.g., four seconds prior to leaving the speaker post before it continues to track and/or stores any information for such vehicle. This feature accounts for drive-bys and trailers being towed by vehicles in the drive-thru. Likewise, if a set amount of time, e.g., twenty seconds, passes after a vehicle has left the speaker post but before the system registers that the car has reached the pay or pick-up window, the vehicle may be considered as having driven away. When either of these scenarios occur, data for the vehicle is dropped by the real-time drive-thru timer 15.

According to a preferred embodiment, upon receiving vehicle event information from the vehicle detection devices, the real-time drive-thru timer 15 is configured to report the vehicle event information to the control and reporting module 20 using one of three modes: short mode, long mode and processed mode. According to one embodiment of the present invention, the selected mode may be selected via a graphical user interface.

In the short mode, the real-time drive-thru timer 15 simply echoes information received from the vehicle detectors to the control and reporting module 20. Therefore, immediately after a transmission is sent from a vehicle detection device indicating that a vehicle is present, or that a vehicle is no longer present, the real-time drive-thru timer 15 transmits the vehicle event information to the control and reporting module 20. The vehicle event information is transmitted in real-time, and no acknowledgement occurs that the information is received by the control and reporting module 20. For instance, in systems having two vehicle detection devices located at order and pickup locations, as a vehicle arrives or departs each location the real-time drive-thru timer 15 sends messages indicating as such. In short mode the real-time drive-thru timer 15 makes no reference to the time at which the vehicle events occur or to a sequence number indicating what transaction (i.e., vehicle) the message refers to. Nevertheless, because this vehicle event information is transmitted in real-time, the control and reporting module 20 can process the vehicle event information with reference to its internal clock to determine relative timing information, as explained in detail below. It should also be appreciated that where multiple cars are positioned at locations monitored by vehicle detection devices, the real-time drive-thru timer 15 will transmit vehicle event information to the control and reporting module 20 representing the status of each of the locations every time any one of the vehicle detection devices changes state—i.e., if the detection device transmits a message indicating a vehicle has arrived or departed.

In long mode, once a vehicle detection device communicates the arrival or departure of a vehicle to the real-time drive-thru timer 15, the real-time drive-thru timer 15 will transmit the same vehicle event information as is transmitted in short mode, along with a sequence number indicating the vehicle the information relates to. In this mode the real-time drive-thru timer 15 will also wait for an acknowledgment transmitted by the control and reporting module 20 that the vehicle event information was received from the control and reporting module 20. Optionally, in long mode the real-time drive-thru timer 15 can transmit a time stamp to the control and reporting module 20 which corresponds to each event.

Time stamps are relative times, measured in tenths of seconds, of events and are based on an internal clock (not illustrated) of the real-time drive-thru timer 15. This clock is synchronized with a clock of the control and reporting module 20. Therefore, regardless of the time depicted on either clock, the time since an event can be easily calculated by the control and reporting module 20 by subtracting the time stamp from the current time. According to one aspect of the invention, the internal clock of the real-time drive-thru timer 15 and clock of the control and reporting module 20 count in 0.1 second intervals, each 0.1 second interval being 1 count. The count begins at 1 and ends at 32768 (or 2\hat{ }15) counts. The clock rolls over after 32768 counts.

As noted above, in long mode, after transmitting vehicle event information to the control and reporting module 20 the real-time drive-thru timer 15 waits for an acknowledgement that the information has been received by the control and reporting module 20. If the control and reporting module 20 does not send an acknowledgement that the vehicle event information was received, the real-time drive-thru timer 15 stores the vehicle event information in the vehicle event information database 65 and continues attempting to transmit the vehicle event information to the control and reporting module 20. The vehicle event information is stored such that the real-time drive-thru timer 15 retains all vehicle event information so that it may be communicated to the control and reporting module 20 after the communication line is reestablished should the communication between the real-time drive-thru timer 15 and the control and reporting module 20 be interrupted (e.g., where the control and reporting module 20 is turned off). Furthermore, the primary purpose of time stamping by the real-time drive-thru timer 15 is to allow the system 10 to process vehicle event information not transmitted to the control and reporting module 20 in real-time. Therefore, the system need not rely on the control and reporting module's clock to indicate the time at which a vehicle event occurs.

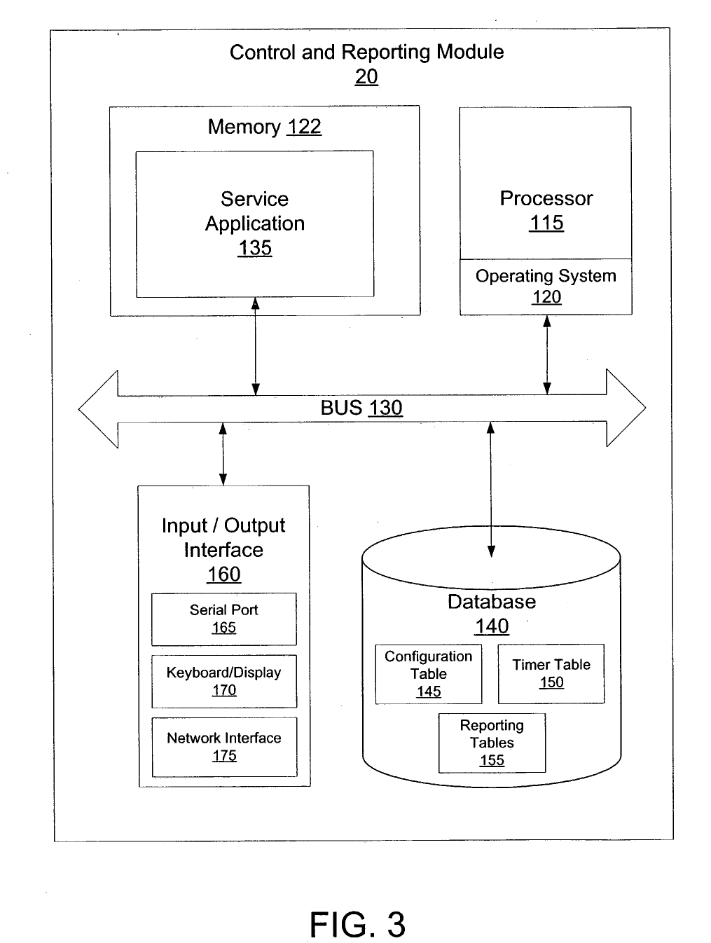

In the short and long modes, each event is transmitted independently. For instance, separate time stamps are sent when a vehicle stops at an order post and at a pickup window. The third mode in which the timer 15 may operated is the processed mode. In this preferred mode the real-time drive-thru timer 15 does not send a communication to the control and reporting module 20 after each individual vehicle event. Rather, after a vehicle leaves the pickup window, the real-time drive-thru timer 15 processes all of the vehicle event information and forwards the information to the control and reporting module 20, and more specifically, a service application therein, as will be discussed with reference to FIG. 3.

The processed mode transmits a data record representing the vehicle event information. The data record is described next with reference to Table 1, which shows the individual components comprising the data record forwarded by the real-time drive-thru timer 15 to the control and reporting module 20 in processed mode.

TABLE 1
Processed Mode Data

| Data Representation | Data |
|---|---|
| Nnnn | Message sequence number |
| Pre In (i.e., Pre-Order | Pre In time in 0.1 seconds |
| Location In) | |
| Pre Out (i.e., Pre-Order | Pre Out time in 0.1 seconds |
| Location Out) | |
| Menu In | Menu In time in 0.1 seconds |
| Audio Detect | Audio Detect time in 0.1 seconds |
| Menu Out | Menu Out time in 0.1 seconds |
| Pay In | Pay In time in 0.1 seconds |
| Pay Out | Pay Out time in 0.1 seconds |
| Pickup In | Pickup In time in 0.1 seconds |
| Pickup Out | Pickup Out time in 0.1 seconds |
| Time | Time at message send in 0.1 seconds |

Data records forwarded by the real-time drive-thru timer 15 to the control and reporting module 20 during processed mode are best described with reference to an illustrative data record:

3457:−2:−2:7946:8005:8322:8432:8436:8438:8749:8792

This data record follows the format shown in Table 1. Therefore, the first four digits (nnnn) identify the message sequence number, 3457. The message sequence number starts at 1 and increases by 1 for each vehicle passing through the drive through. The number may be reset by the system upon startup, such as at the beginning of the day. Alternatively, the number can continue incrementing until it reaches its maximum value (based on the number or bits desired for the transmission) and resets to 1.

Next, in the illustrative example both the Pre In and Pre Out data, read −2. This number is a default number stored by the real-time drive-thru timer 15 and used when the real-time drive-thru timer 15 does not monitor the presence or absence of vehicles at a pre-order post. Alternatively, where a vehicle detection device is at such a location the real-time drive-thru timer 15 may record a time, in 0.1 second increments, for both of such values. The seven numbers beginning at the fourth data element, 7946, correspond to time stamps at which the: vehicle arrived at the menu location (7946), drive-thru employee initiated an audio connection to communicate with the customer, as identified by an audio detection circuit in communication with the real-time drive-thru timer 15 (8005), vehicle left the menu location (8322), vehicle arrived at the pay location (8432), vehicle left the pay location (8436), vehicle arrived at the pickup location (8438), vehicle left the pay location (8749), and message is transmitted (8792). When a time-out occurs, as occurs when a vehicle drives off, the message is transmitted with the missing fields being set to −1. Messages transmitted by the timer 15 can be terminated by a return character, a linefeed, or both. Additionally, messages are acknowledged as received by the control and reporting module 20 by the return of the sequence number followed by a return character, linefeed, or both. This acknowledgement method is also used in the long mode.

In the long and processed modes, after an acknowledgment is received from the module 20, the timer 15 can delete the vehicle event information. For instance, in the processed mode, after an acknowledgement is received by the timer 15 that the module 20 received a data record, the data record is deleted. Nevertheless, before such deletion the timer 15 retains data necessary for the timer 15 to calculate information necessary to run the displays. For instance, if one of the displays is configured to show an average total time vehicles are in the drive-thru, the timer 15 will utilize the vehicle event information to determine the moving average of the total time vehicles remain in the drive-thru. These calculations are executed by the processor 45 and firmware 50 and are stored as display data stored in the display data database 70 located within the memory 60. Therefore, even if the timer 15 loses communication with the module 20, the displays will work because the real-time drive-thru timer 15, not the control and reporting module 20, is driving the displays 25, 30, 35, 40.

The timer communicates with the displays 25, 30, 35, 40 to generate the user-configurable displays enabled by the present invention. As explained in detail with reference to FIGS. 3, 8 and 9, considered below, a user customizes the type of information the user wishes to be presented on the displays using the control and reporting module 20. This information can include, for instance, vehicle pendency information based on the vehicle event information and/or customized messages regarding the performance of the drive-thru. Once a user selects display settings that control the data presented by the displays, these settings are transmitted from the control and reporting module 20 to the real-time drive-thru timer 15. Although this will occur upon startup of the system 10, any change in the display settings by a user will be transmitted to the real-time drive-thru timer 15 so long as the module 20 and timer 15 are in communication.

In addition to the display settings, the control and reporting module 20 also communicates user-configurable goals to the real-time drive-thru timer 15 for storage in the memory 60. The goals enable the timer 15 to display the customized messages which identify the performance standard being met by the drive-thru employees. The control and reporting module 120 enables the user to input up to three goals for each user-defined daypart. The goals are input by a user in seconds, typically in ascending order. The real-time drive-thru timer 15 then compares the total time a vehicle remains in the drive against these goals to determine which goal is met. The real-time drive-thru timer 15 can display different customized messages on the displays 25, 30, 35, 40 depending on the goal that is met. The customized messages, as will be explained next, may be illustrated simultaneously with vehicle pendency information.

As illustrated in FIG. 1, a plurality of displays 25, 30, 35, 40 may be used in the system 10. According to a preferred embodiment of the present invention, each display can display up to four options, including: Passive Left, Passive Right, Active Left and Active Right. The options may be presented on one two display fields—either the left or right side of the display. Therefore, the displays are generally split in two, such that the displays can simultaneously display information on the right and left hand side of each display. Therefore, the possible display options by each display are illustrated in Table 2:

TABLE 2
Display Options
Display Options
Passive Left/Passive Right
Active Left/Active Right
Passive Left
Passive Right
Active Left
Active Right

If only a right or left option is defined, it is centered in the display. Otherwise, if both are displayed they are separated by a “:” character. The display settings are stored in the display settings database 67 within the memory 60. According to one aspect of the present invention, each option can have a defined color that changes depending on how quickly the drive-thru is servicing a vehicle. For instance, the color of the displays may change based upon whether a user-configurable goal is met. By default the passive options are continuously displayed by each display, and the active options override the passive display positions only when a vehicle is in the position related to the active option, and for 20 seconds thereafter. Generally, passive options display averages, and active options display the length of time a vehicle has remained at a specific location, or in between locations of the drive-thru.

The vehicle detector inputs 75 and/or firmware 50 operating in conjunction with the processor 45 provides active timers for the menu, pay and pickup locations of the drive-thru, such that when a vehicle is in one of those positions, the corresponding timer for that position is set and will remain set for 20 seconds after the vehicle leaves that position. Thus, when the vehicle is in one of those positions, the displays may display the active information selected by the user. The following are a list of display settings that may populate the left and/or right portions of the display. The data on the Display is shown with a 2 character abbreviation to identify the data. This aids with employee training:

TABLE 3
Display Settings
Display Settings
TC - Total Vehicles In Queue
TL - Current/Last Total
TD - Total DayPart Average
TA - Total Day Average
Total % Under Goal
PT - Current/Last Pickup Time (Active if Pickup timer is Set)
PD - Pickup DayPart Average (Active if Pickup timer is Set)
PA - Pickup Day Average (Active if Pickup timer is Set)
P % - Pickup % Under Goal (Active if Pickup timer is Set)
$T - Current/Last Pay Time (Active if Pay timer is Set)
$D - Pay DayPart Average (Active if Pay timer is Set)
$A - Pay Day Average (Active if Pay timer is Set)
$% - Pay % Under Goal (Active if Pay timer is Set)
MT - Current/Last Menu Time (Active if Menu timer is Set)
MD - Menu DayPart Average (Active if Menu timer is Set)
MA - Menu Day Average (Active if Menu timer is Set)
M % - Menu % Under Goal (Active if Menu timer is Set)

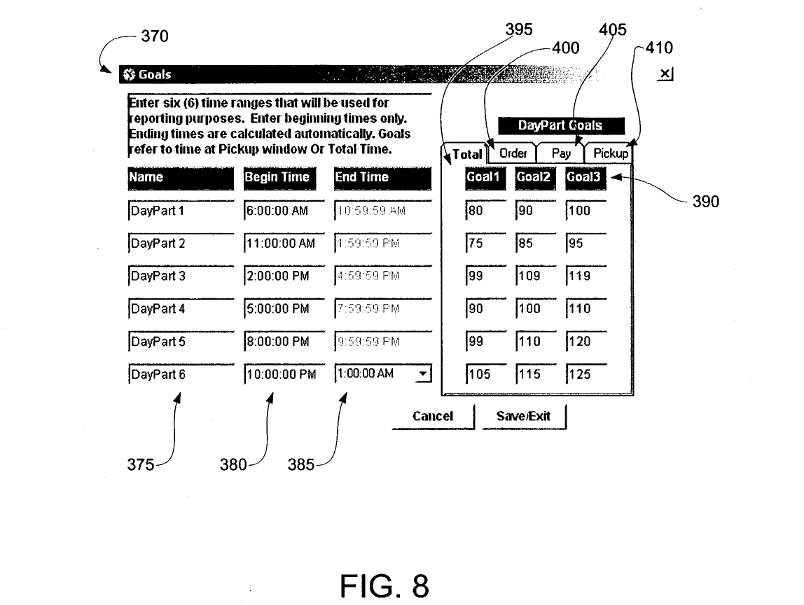

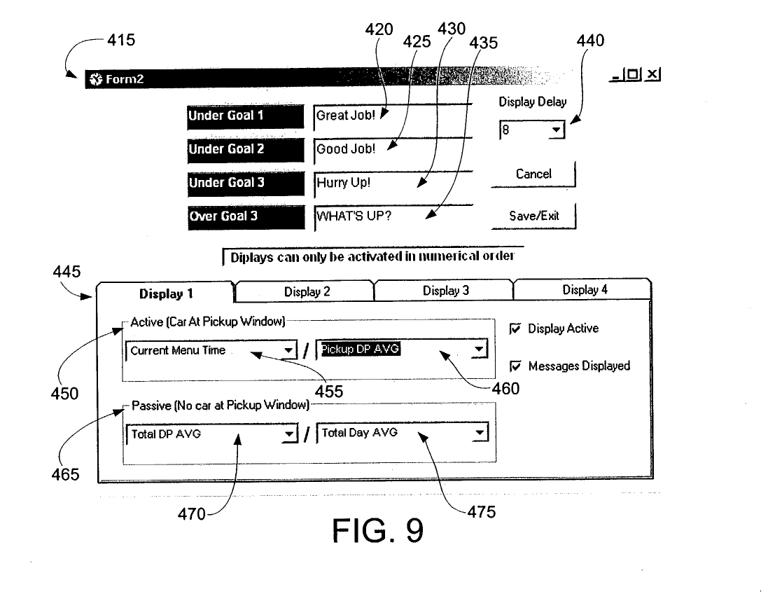

Each of the values represented in Table 3 may be calculated by the real-time drive-thru timer 15 based on the vehicle event data described above. Specifically, the firmware 50 can utilize the internal clock and or timestamps at which relative events occur to calculate the above information, which is stored in the display data database 70 in memory 60. However, it should be appreciated that the timer 15 only calculates and stored the display data necessary to run the displays 25, 30, 35, 40. Thus, where, for instance, the system 10 does not include a vehicle detection device located at a pay window, or the pay window information is not selected by the user as a field the user wishes to view via one of the displays 25, 30, 35, 40, the timer 15 need not calculate and store vehicle data related to the pay window. It will also be appreciated that because a user can configure the displays to display information concerning events at separate locations of the drive-thru, such as the menu time and pay window, the displays 25, 30, 35, 40 can concurrently display data for separate cars in the drive-thru. The generation of the displays from the display data be described in greater detail with reference to FIGS. 8 and 9, below.

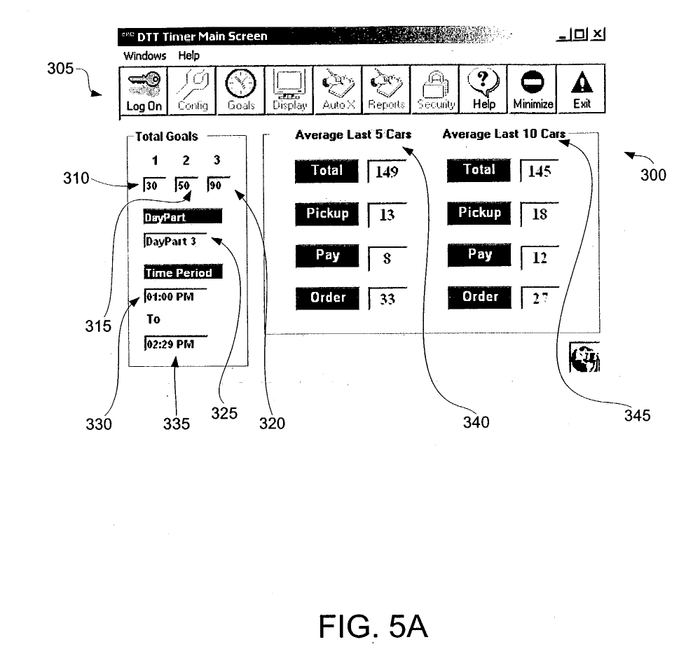

Next, FIG. 3 shows a block diagram illustrating components comprising a control and reporting module 20 of the real-time drive-thru timing system 10, according to one aspect of the present invention. The control and reporting module 20 is the primary operator interface for operating the system 10. Therefore, the control and reporting module accepts, via graphical user interfaces (GUIs), system setup information, customized message information (i.e., the customized messages to be displayed by the displays 25, 30, 35, 40 via the real-time drive-thru timer 15), report creation information, report storage information, and additional information as will be described with reference to FIGS. 5-12. The control and reporting module 20 also manipulates the vehicle event information forwarded from the real-time drive-thru timer 15 to enable a user to produce customized reports.

According to a preferred embodiment of the present invention, the control and reporting module 20 comprises software running on a conventional personal computer. As with the real-time drive-thru timer 15, the present invention may be embodied as a method, a data processing system, or a computer program product. Accordingly, the present invention may take the form of an entirely hardware embodiment, an entirely software embodiment or an embodiment combining software and hardware aspects. Furthermore, the present invention may take the form of a computer program product on a computer-readable storage medium having computer-readable program code means embodied in the storage medium. Any suitable computer-readable storage medium may be utilized including hard disks, CD-ROMs, optical storage devices, or magnetic storage devices.

As shown in FIG. 3, the control and reporting module 20 comprises a processor 115, an operating system 120, a memory 122, an input/output interface 160 and a database 140, in communication via a bus 130. Briefly, the processor 115 works in tandem with an operating system 120 and the service application 135 to execute the functions described herein. The memory 122 in which the service application 135 resides may comprise random access memory, read-only memory, a hard disk drive, a floppy disk drive, a CD Rom drive, or optical disk drive, for storing information on various computer-readable media, such as a hard disk, a removable magnetic disk, or a CD-ROM disk. Likewise, the database 140 may also comprise such computer-readable media.

As will be appreciated by one of ordinary skill in the art, the service application 135 is connected to the bus 130 by an appropriate interface. The service application 135 and database 140 and their associated computer-readable media provide nonvolatile storage for the control and reporting module 20. However, it is important to note that the computer-readable media described above could be replaced by any other type of computer-readable media known in the art. Such media include, for example, magnetic cassettes, flash memory cards, digital video disks, and Bernoulli cartridges. Furthermore, it will be appreciated by one of ordinary skill in the art that one or more of the control and reporting module 20 components may be located geographically remotely from other control and reporting module 20 components. Furthermore, one or more of the components may be combined, and additional components performing functions described herein may be included in the control and reporting module 20.

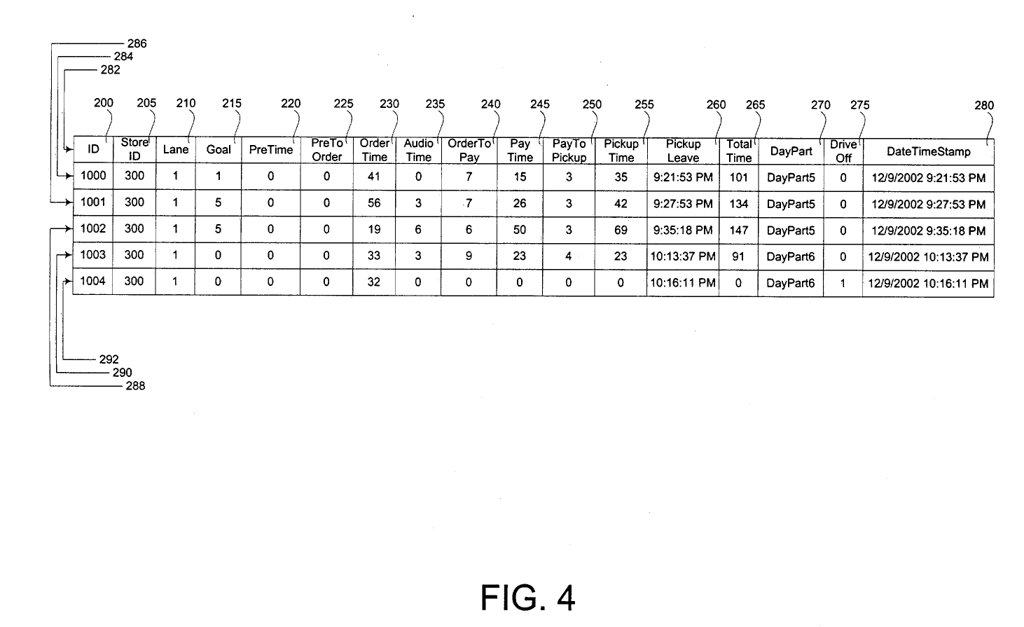

The service application 135 receives, via a first serial port 165 or a network interface 175, vehicle event information forwarded by the real-time drive-thru timer 15. When the real-time drive-thru timer is operating in full or processed mode, as detailed above, the service application 135 transmits an acknowledgement to the real-time drive-thru timer 15 that the vehicle event information was received. The service application 135 then manipulates this vehicle event information to generate vehicle timing data which is stored in timer table 150 of the database 140. More specifically, for each vehicle that passes through the drive-thru the service application 135 generates vehicle timing data stored in a single line item in the timer table 150. The vehicle timing data is used by the service application to generate customized reports, as described in detail below. FIG. 4, described in detail below, shows an illustrative example of vehicle timing data output by the service application 135 for five vehicles based on vehicle event information received for the five vehicles from the real-time drive-thru timer 15.

The service application 135 also enables a user to enter a large number of configuration and customized options via the input/output interface 160, and more specifically, via a keyboard and/or display 170. Preferably, the service application 135 provides multiple graphical user interfaces (GUIs) through which a user can configure and customize the system 10. More specifically, using the service application 135 the user can control the type of messages and the manner in which messages are displayed to drive-thru operators on the displays 25, 30, 35, 40. Additional configuration settings that can be controlled via the service application also include goals that should be met by the drive-thru operators for different dayparts, the mode in which the real-time drive-thru timer 15 reports (i.e., short, long or processed mode), and additional settings described hereinafter. These configuration settings are stored in the configuration table 145 within the database 140. Furthermore, using the service application 135 and one or more GUIs provided by the service application 135, the user can customize, print and store customized reports. To effect the generation of such reports the service application may manipulate data and store the data in one or more reporting tables 155 within the database 140.

The functions provided by the service application 135 will be described in detail with reference to FIGS. 5-12. Next, however, the creation of vehicle timing data by the service application 135, and the storage of such data in the timer table database 150, will be described in detail.

FIG. 4 shows an illustrative example of vehicle timing data for five vehicles generated by the control and reporting module based on vehicle event information received from the real-time drive-thru timer. More specifically, for each of the five vehicles that pass through the drive-thru, the service application 135 generates a corresponding line item 284, 286, 288, 290, 292 containing vehicle timing data. The vehicle timing data for each vehicle comprises, according to a preferred embodiment of the present invention, seventeen fields 282 populated by the service application 135 based on the vehicle event data received from the real-time drive-thru timer 15. These fields 282 are used by the service application 135 to generate customized reports generated by a user. According to one aspect of the invention, the customized reports include the vehicle timing data included in the fields 282, or averages computed by the service application 135 based on the fields 282, including averages calculated for each daypart, or averages for an hour, half-hour or quarter-hour of elapsed time.

The ID field 200 indicates the message sequence number of the vehicle. This number starts at 1 and increments by 1 for each successive vehicle passing through the drive-thru. Therefore, each line item, and each vehicle, may be identified by the sequence number. Next, the Store Id field 205 identifies the store. This information may be beneficial where the control and reporting module is accessible via a network connection such as the Internet. As such, the access of vehicle timing data will clearly identify, in numeric form, the store at which entries concern. Next, the Lane field 210 identifies the lane through which a customer vehicle was served. This field is important where the present invention is employed at a business having two or more lanes. Therefore, it will be appreciated that although the present invention is described herein with reference to a single lane drive-thru, the invention is also capable of monitoring two or more lanes simultaneously.

Next, the Goal field 215 indicates the goal that is met by the drive-thru operators in servicing a vehicle. The service application 135 enables the user to input up to three goals for each user-defined daypart. The goals are input by a user in seconds, typically in ascending order. The total time a vehicle remains in the drive through, the TotalTime field 265, is then compared against these preset goals to determine which goal is met. The goal that is met is listed in the line item under the goal field 215. According to one embodiment of the invention, if the first goal is met the number in the goal field 215 is 1, if the second goal (but not the first goal) is met the number in the goal field 215 is 2, if the third goal (but not the first or second goal) is met the number in the goal field 215 is 3, and if none of the goals are met the number in the Goal field 215 is 5.

Referring again to FIG. 4, the PreTime field 220 is the length of time a vehicle remained at a pre-order display location. In each of the line items 284, 286, 288, 290, 292, this value is zero because the system in this illustrative example does not include a pre-order display or a vehicle detection device at a pre-order display. For this same reason, the next field, the PreToOrder field 225 is also zero. This field indicates the length of time that elapses between the vehicle departing the pre-order display location and arriving at the menu location.

The OrderTime field 230 is the length of time that elapses from the arrival of a vehicle at the menu location until the vehicle departs the menu location. The AudioTime field 235 is the length of time which passes after the vehicle arrives at the menu but prior to a drive-thru employee initiated an audio connection to communicate with the customer. To monitor this time, an audio detection circuit in communication with the real-time drive-thru timer 15 registers a timestamp when audio is detected. This information is forwarded to the control and reporting module 20 as described above with reference to the illustrative data record following Table 1.

The next field, the OrderToPay field 240, is the length of time that lapses between a vehicle's departure from the order menu to the vehicle's arrival at the pay window. The PayTime field 245 is the length of time the vehicle is positioned at the pay window. Furthermore, the PaytoPickup field 250, is the length of time that lapses between a vehicle's departure from the pay window to the vehicle's arrival at the pickup window. Similarly, the PickupTime field 255 is the length of time the vehicle is positioned at the pickup window. The time at which the vehicle departs the pickup window is registered in the Pickup Leave Field 260, and is used to compute the TotalTime field 265, which is the total time a vehicle remained in the drive-thru.

Next, each line item includes an indication as to which daypart the vehicle was served in. Dayparts, as noted above, are segments of the day, and each segment may be assigned a daypart number. For instance, a lunch shift may have a daypart number of 3, whereas a dinner shift may have a daypart number of 5. If vehicles driveoff, as discussed above, the line item may signify a ‘1’ in the driveoff field 275, as is the case with line item 292. Finally, the DateTimeStamp setting is the time at which the vehicle event information, which was the basis for populating the line item, was transmitted to the control and reporting module 20.

As an illustrative example as to how the real-time drive-thru timer 15 and control and reporting module 20 populate each field, consider the TotalTime field 265 in a system operating in the processed mode. To determine this value for a particular vehicle, upon the arrival of a vehicle at the menu location, the vehicle detection device forwards a message to the vehicle detector inputs75 that a vehicle is present at the speaker post. Upon receiving indication of the vehicle's presence to the speaker post, the firmware 50 and processor 45 store the time indicated by the timer's 15 clock. After the vehicle leaves the pickup window, vehicle event information including the menu arrival timestamp (assuming no pre-order location is monitored) and the pickup departure timestamp is transmitted to the control and reporting module 20. The service application 135 of the control and reporting module 20 subtracts the arrival time at the menu from the departure time to determine the TotalTime field 265. The functions of the real-time drive-thru timer 15, control and reporting module 20, and displays 25, 30, 35, 40 will further be described with reference to FIGS. 5-13.

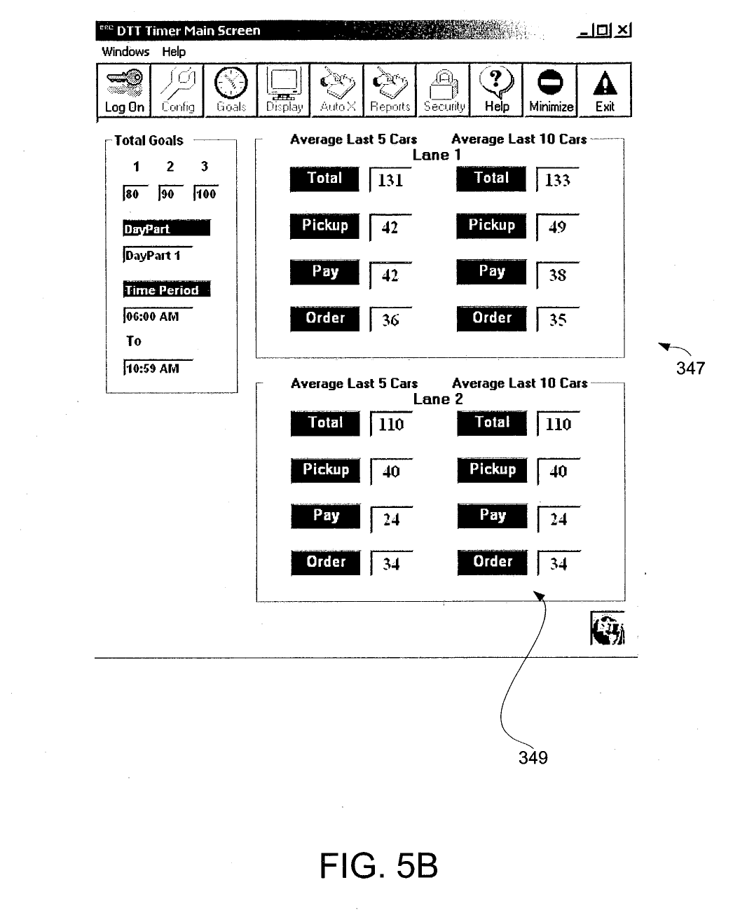

FIG. 5A shows a graphical entry interface 300 for operating the control and reporting module 20, according to one aspect of the present invention. The entry interface 300 includes a tool bar 305 used to activate the tools needed to configure the system 10 and to generate customized reports. FIGS. 6-12 present the Tool Bar Functions in the order of their occurrence on the tool bar 305 from left to right. The graphical entry interface 300 presents the primary data and control buttons needed to monitor and maintain the service application 135. The data fields are for display only; therefore, no changes can be made to the data fields on this interface 300.

As shown in FIG. 5A, the interface 300 includes three goal fields 310, 315, 320 illustrating three goals, in seconds, configured for the present daypart 325, where the range of the daypart is defined by two time 330, 335. The goal and daypart data is configurable from the Goals Maintenance GUI illustrated in FIG. 8. The right hand side of the interface 300 displays average vehicle data for the last 5 cars 340 and for the last 10 cars 345. This data is based upon the vehicle timing data stored by the control and reporting module, and may be calculated as an average from past vehicle line items stored in the timer table 150. As illustrated in FIG. 5A, the average total time for a vehicle to pass through the drive through is shown, along with the average time the vehicle spends at the pickup, pay and order stations. FIG. 5B shows another embodiment of a graphical entry interface 347, wherein the graphical user interface includes average vehicle data 349 for a second drive-thru lane in addition to the information provided by the interface 300 of FIG. 5A.

FIG. 6 shows a graphical log-on screen 350 for logging into the control and reporting module 20, according to one aspect of the present invention. Logging on is preferably the first step to configure the system 10 of the present invention, and until a user is logged on, the system cannot be configured and none of the fields may be changed using the GUIs described herein. The log-on screen 350 is accessed from the tool bar 305 of the graphical entry interface 300. The log-on screen 350 displays the StoreId, address, storename, and state of the store in which the system is set up. This data is collectively referred to as store registration information 355. The log-on screen also requires a user to enter a password 360 in order to configure the system 10.

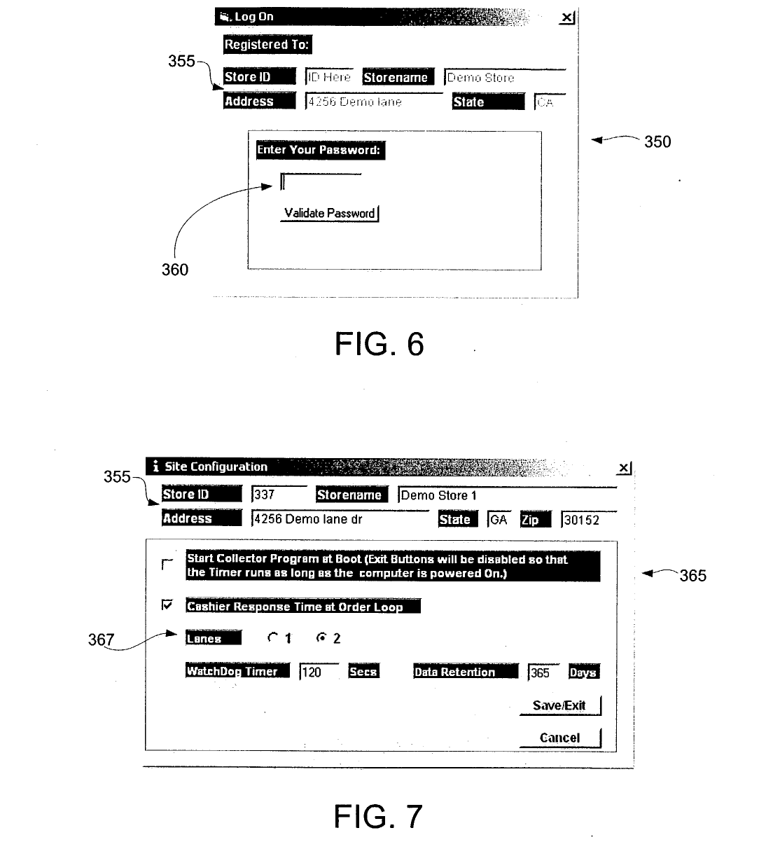

Next, FIG. 7 shows a graphical configuration interface 365 for configuring the control and reporting module, according to one aspect of the present invention. The graphical configuration interface 365 is accessible from the tool bar 305 of the graphical user interface. The graphical configuration interface 365 enables a user to input the store registration information 355 displayed by the log-in screen. The StoreId is entered to identify the store for reporting purposes and each report that may be produced by the control and reporting module 20 will include a heading that contains the store identification. Additionally, when multiple stores report to a group corporate entity, this information will be used to identify the store from which the vehicle timing data is collected.

As illustrated in FIG. 7, the graphical configuration interface 365 also includes a user-selectable check box that will cause the interface to start automatically when the PC on which it runs is powered up or rebooted. Therefore, should the user toggle the box to display a check mark, the interface will run automatically (unless the computer on which it runs is turned off). Next, the interface 365 includes a cashier response time check box. This check box, if it is selected, enables the audio detection feature described above, which enables the system 10 to record the time that elapses after a vehicle arrives at a menu board but before a drive-thru employee begins to communicate with the vehicle. This is typically turned off (i.e., not checked) if the drive-thru does not include an audio detect circuit.

FIG. 7 also shows a watchdog timer field and a data retention field. Both are configurable by a user. The watchdog timer represents a threshold designating a vehicle's time to be considered an exemption for reporting purposes. An exception may or may not have a valid order, but it cannot be properly timed. As an illustrative example, if the drive-thru lane is clear and a car drives over the menu detect point and then leaves the drive-thru lane, the service application 135 will consider the car an exemption if the car takes longer than the watchdog time to arrive at the next vehicle detection point in the drive-thru. Therefore, a user may set the watchdog field to the maximum reasonable time, in seconds, for a car to travel from one vehicle detection device to the next vehicle detection device when there are no other vehicles in the drive-thru lane. Next, the data retention field enables a user to enter a period of time, in days, that data is accumulated and stored in the timer table 150 for reporting purposes.

FIG. 8 shows a graphical goal entry interface 370 for creating goals in the control and reporting module 20, according to one aspect of the present invention. The goal entry interface 370 is accessible from the tool bar 305 located on the graphical entry interface 300. The goal entry interface 370 includes six dayparts 375, each having a user-configurable begin time 380 and end time 385. The name of each daypart is also configurable (e.g., dayparts can be titled “breakfast”, “lunch”, “afternoon”, etc.). The interface 370 also includes configurable first, second and third goals 390 for each of the following: the total time 395 for a vehicle to pass through the drive-thru, and the length of time a vehicle spends at respective order 400, pay 405 and pickup 410 locations.

It will be appreciated that goals are maintained for each of the six dayparts or time ranges defined by a user. If a business does not want to divide a day into six dayparts, then the daypart names can be changed to indicate “Closed” or another suitable message. For each daypart the begin time 380 may be entered by a user. The end time 385 may be calculated by the service application 135 automatically based on when the next daypart begin time occurs.

The user-configurable goals 390 define three grades or levels that the drive-thru operator should achieve for each daypart. For instance, referring to the data fields illustrated in FIG. 8, during daypart 1, goal 1 is met if the total time 395 a vehicle remains in the drive-thru is 80 seconds or less. Goal 2 is met if the vehicle remains in the drive-thru between 81 and 90 seconds, and Goal 3 is met is the vehicle remains in the drive-thru between 91 and 100 seconds. Therefore, Goal 1 is typically set as the optimum service time the drive-thru service should meet, Goal 2 is typically set at the likely service time the drive-thru service should meet, and Goal 3 is typically set as the maximum allowable service time. Times exceeding Goal 3 are deemed unacceptable.

It will be appreciated that three goals are not only configurable for the total time 395 a vehicle remains in the drive-thru for each daypart 375, but also for the length of time a vehicle spends at respective order 400, pay 405 and pickup 410 windows or locations. Therefore, the total number of user-configurable goals is 6 (total number of dayparts)*3 (three goals for each daypart)*4 (total number of fields having a configurable goal), which totals 72 user-configurable goals. Like all other user-configurable data input into the GUIs provided by the service application 135, the data entered by a user at the graphical goal entry interface 370 is stored in the configuration table 145 of the control and reporting module 20. This goal information is also transmitted by the control and reporting module 20 via the serial port 165 or network interface 175 to the real-time drive-thru timer 15, where the real-time drive-thru timer requires the goal information to run the displays 25, 30, 35, 40.

FIG. 9 shows a graphical user-configurable display interface 415 for configuring messages to be displayed to a user by the real-time drive-thru timing system 10. The display interface 415 is accessible from the tool bar 305 located on the graphical entry interface 300. The display interface 415 includes four customized messages 420, 425, 430, 435. As illustrated in FIG. 9, each of these messages is a customized message displayed when a goal is met (in the case of messages 420, 425, 430) or exceeded (in the case of message 435). Therefore, where Goal 1 is met, the text of the first customized message 420 may be displayed. Where Goal 2 is met (but Goal 1 is not), the text of the second customized message 425 may be displayed. Likewise, where Goal 3 is met (but Goals 1 and 2 are not), the text of the third customized message 430 may be displayed. Finally, where none of the goals are met, the text of the fourth customized message 435 may be displayed.

The messages displayed by each of the displays 25, 30, 35, 40 are configurable using a display configuration tool 445 of the user-configurable display interface 415. As described with respect of FIG. 2, each display 25, 30, 35, 40 can display messages on two fields (i.e., the right or left sides of the display) simultaneously, and user-configurable display options are generally configured into either active 450 and passive 465 messages. Referring again to FIG. 9, the display configuration tool 445 enables a user to configure the active left and right message fields 455, 460 and passive left and right message fields 470, 475 for each display. Therefore, the left and right display fields may change depending on the active or passive status of each lane. A lane status is active if there is a vehicle present at the pickup window, and is passive if a vehicle is not located at the pickup window.

The active message fields 455, 460 are used to select the display messages displayed by each display at the times when a vehicle is at the chosen window. A drop-down menu allows a user to select the display settings, such as those illustrated in Table 3, for the left 455 and right 460 display fields. Likewise, the passive message fields 470, 475 are used to select the display messages displayed by each display at the times when vehicles are not the chosen window. A drop-down menu allows a user to select the display settings, such as those illustrated in Table 3, for the left 470 and right 475 display fields. It will be appreciated that the additional displays are configured such that the active and passive status depends on whether vehicles are located at the window corresponding to the Active Right criteria for each sign.

All of the user-configurable display messages 420, 425, 430, 435, 455, 460, 470, 475 (and those additional messages corresponding to displays having fields not illustrated in FIG. 9) are stored in the configuration table 145 of the control and reporting module 20 and are transmitted to the real-time drive-thru timer 15 each time the settings are changed. The real-time drive-thru timer 15 stores the display configuration information in the display settings database 75 in memory 60, such that the timer 15, and more specifically, the firmware 50 and processor 45, can effectively generate the customized messages on each display 25, 30, 35, 40 using the display data 70 stored therein.

The display data field 440 controls the amount of time the last vehicle's data will be displayed after another vehicle pulls to the chosen window. According to a preferred embodiment, the display data field 440 includes a pull down menu allowing a user to select a number of seconds from 1 to 9. Each display will then display the user-configurable display messages described above for the number of seconds selected by this field 440, even if a following vehicle immediately arrives at the final detection loop (i.e., at the pickup window).

The four customized messages 420, 425, 430, 435 are displayed by the timer 15 at least one of the displays each time a vehicle pulls away from the final detection loop. The messages displayed change after each goal is passed and may be displayed for a preset length of time, such as 20 seconds. The first message, Message 1, displays if time for Active Left is under goal 1. The second message, Message 2, is displayed if time for Active Left is between goal 1 and goal 2. The third message, Message 3, is displayed if time for Active Left is between goal 2 and goal 3. The fourth message, Message 4 is displayed if time for Active Left is above goal 3.

Finally, the graphical user-configurable display interface 415 also includes check-boxes allowing a user to configure whether each display is active, or whether the user-selected messages are displayed. It will also be appreciated that although the display interface 415 is illustrated as enabling a user to configure customized messages for four displays 445. However, it should be appreciated that additional displays may also be used and configured using the present invention.

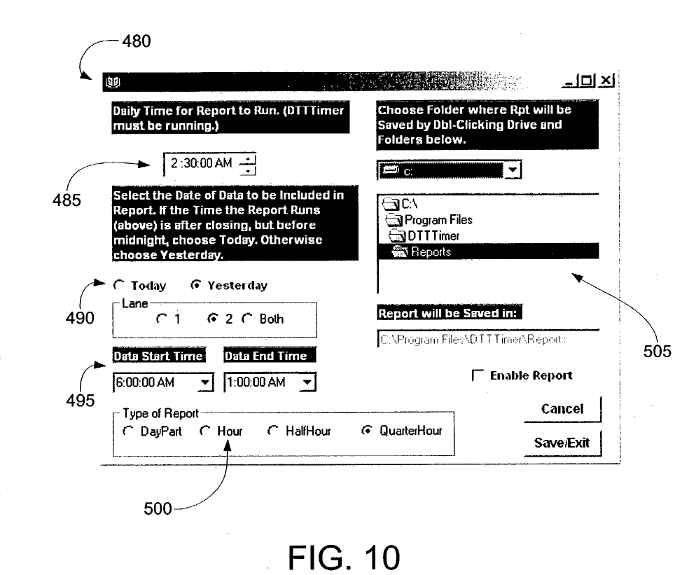

FIG. 10 shows a graphical reporting execution interface 480 which enables a user to generate reports, according to one aspect of the present invention. The graphical reporting execution interface 480 is accessible from the tool bar 305 located on the graphical entry interface 300. The interface 480 includes a daily time field 485 configurable by the user which allows the user to set a time by which a report may automatically run. The time may be manually typed by a user or selected by using the up and down arrows. Additionally, the day field 490 allows a user to select whether the report will be automatically generated for the present day (‘today’), or for the previous day (‘yesterday’).

The data start time and data end time fields 495 designates the earliest car entry at the initial vehicle detection location (e.g., at the pre-order or menu location) that will be included in the report, and the latest vehicle exit at the last vehicle detection location (i.e., the pickup window) that will be included in the report. Additionally, the lane selector allows a user to configure whether the report will run for a single lane, or both lanes in drive-thrus having two lanes.

The graphical reporting execution interface 480 includes one or more save windows 505 allowing a user to select a location (or create a location) in memory at which the reports will be saved. According to one aspect of the invention, the reports may be saved in the reporting tables 155 of the memory 140, or to another memory location, including a remote location, in communication with the control and reporting module 20. The reports are preferably saved as a Microsoft Excel™ file though additional formats may be used. It will be appreciated that the service application 135 supports report printing to the Windows default printer. Furthermore, the interface 480 includes a type of report field 500 that allows the user to define the type of summary included in the report, such as a daypart, hour, halfhour or quarterhour summary. This summary may include average vehicle data corresponding to the vehicle timing data tracked generated by the control and reporting module 20 timer 15. The interface 480 may also include a check-box the user may toggle on or off to enable or disable the automatic report generation feature of the present invention.

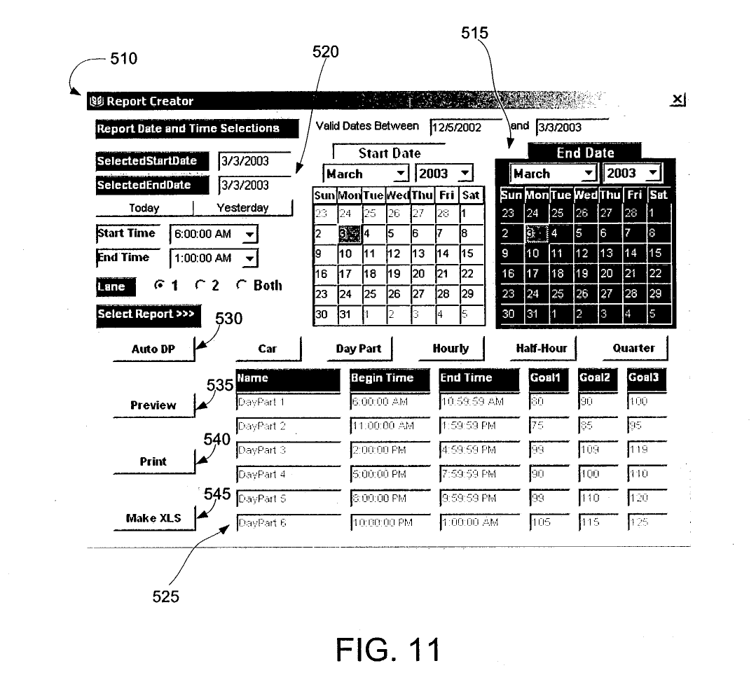

FIG. 11 shows a graphical report creation interface 510 for creating reports, according to one aspect of the present invention. The graphical report creation interface 510 is accessible from the tool bar 305 located on the graphical entry interface 300. Unlike the automated report configured by the graphical reporting execution interface 480, the graphical report creation interface 510 allows a user to configure multiple fields to generate highly customized reports. For instance, a date range for a desired report may be selected using a date interface 520 or a calendar interface 515. Additional criteria, such as the start and end time within each data selected, and the one or more lanes for which the report will be run, are also configurable. Reports may be selected that include data identifying averages of vehicle timing data calculated over a daypart, hour, hour-hour or quarter hour interval. Additionally, the vehicle timing data for every vehicle may be selected via the ‘car’ button. The dayparts, and goals for each are provided on a goal display 525 to allow the user to view the dayparts, hours and goals associated with each so as to aid the user in selected the type of report the user wishes to generate.

The interface 510 includes an Auto DP button 530, a Preview button 535, a print button 540 and a Make XLS button 545. The Auto DP button 530 allows the user to automatically create a daypart report. Pressing this button may bring up an additional GUI asking whether the user wishes to automatically generate a daypart report immediately after the end of each daypart, which the service application identifies by monitoring the internal clock of the control and reporting module. Alternatively, via the additional GUI a user may choose to generate daypart reports only after the end of the day—i.e., after the conclusion of the last daypart. The Preview button 535 allows the user to view the report, or a portion thereof, and the Print button 540 allows a user to print the report to a local or remote printer. Finally, the Make XLS button 545 enables the user to save the report in Microsoft Excel™ format (*.xls) to a user-selected local or remote location.

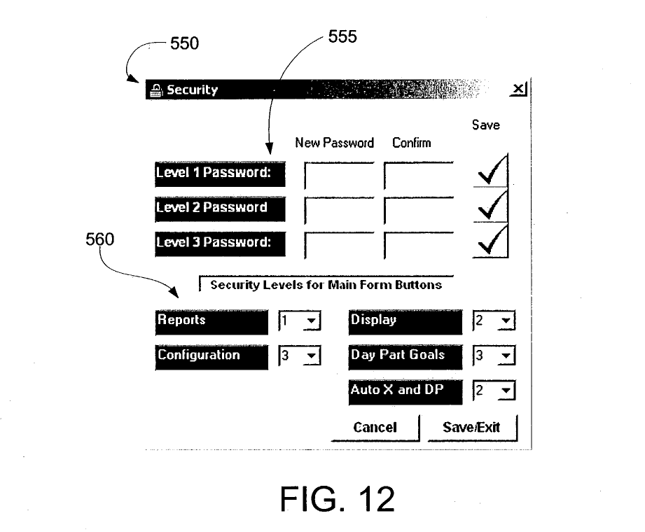

FIG. 12 shows a graphical security interface 550 which enables the creation of multiple access levels for using the control and reporting module, according to one aspect of the present invention. The interface 550 allows for security levels 560 to be assigned to each of the following main functions described above: report generation (‘Reports’, i.e., the interface of FIG. 11), site configuration (‘Configuration’, i.e., the interface of FIG. 7), display customization configuration (‘Display’ i.e., the interface of FIG. 9); goal configuration (‘Day Part Goals’ i.e., the interface of FIG. 8), and auto day report configuration (‘Auto X and DP’ i.e., the interface of FIG. 10). The security levels are whole integers ranging from 1 to 3, which correspond to three levels of security, and each function includes a pull down selection enabling the user to assign the level to each of the main functions.

The interface 550 also includes a password assignment interface 555 that allows a user to assign passwords for the 3 levels of security. The password for each level is assigned by a user for each level by entering it twice. This may be only entered by a system 10 administrator or another person having access to all of the features provided by the service application 135. Once security levels are assigned, a person accessing the graphical entry interface 300 via the graphical log-on screen 350 will only have access to those interfaces having security levels equal to or below the security level assigned to that password. According to one aspect of the invention, the tool bar 305 of the entry interface 300 will only permit a user access to the interfaces (FIGS. 7-11) permitted by the user's security level.

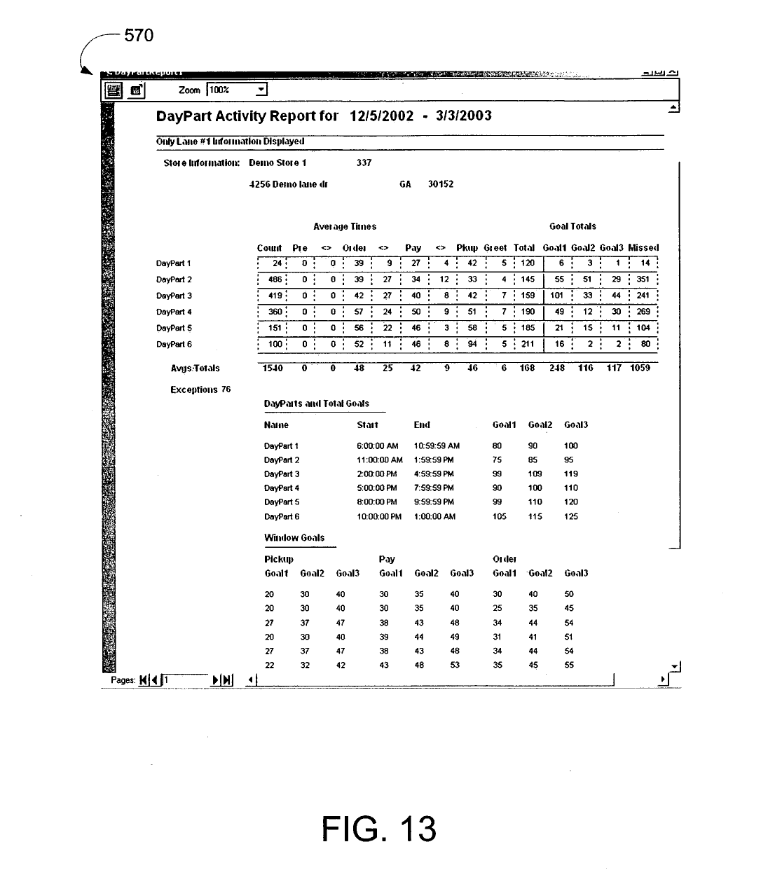

FIG. 13 shows a report 570 generated by the service application 135 of the control and reporting module 20, according to one aspect of the present invention. The report is an illustrative example of a daypart report generated using graphical report creation interface 510. The format for the report is stored in the reporting table 155 of the control and reporting module 20. Therefore, after a user inputs the selected start and end dates 520 for the report 570 using the graphical report creation interface 510 of FIG. 11, and selects the daypart button, the user may view the report 570 after selecting the preview button 535.

The report 570 includes the store registration information 355 at the top of the report 570 and the average times and goal totals met for each daypart, as calculated by the service application 135 using the historical timing data stored in the timer table 150. The average times vehicles waited in and between the locations of the drive-thru, as identified by the vehicle tracking device and stored for each vehicle in a line item, such as those described with respect to FIG. 4, are calculated and displayed by the service application. Additionally, the number of vehicles meeting the respective goals established by the user may be calculated by the service application 135. Additional information displayed in the report includes the dayparts, the total vehicle time goal for the daypart, and the respective window goals (i.e., the order, pay and pickup windows), as described above with reference to the graphical goal entry interface 370 of FIG. 8.

Many modifications and other embodiments of the inventions set forth herein will come to mind to one skilled in the art to which these inventions pertain having the benefit of the teachings presented in the foregoing descriptions and the associated drawings. Thus, it will be appreciated by those of ordinary skill in the art that the present invention may be embodied in many forms and should not be limited to the embodiments described above. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A user-configurable, real-time drive-thru system for analyzing and reporting the time to serve customers in a restaurant drive-thru having at least one vehicle detection device, comprising:
at least one display, wherein said at least one display is viewable by an operator of said restaurant drive-thru;
a drive-thru timer, in communication with said at least one vehicle detection device, wherein said drive-thru timer collects vehicle event information, said vehicle event information based at least in part on the location of a vehicle in the restaurant drive-thru; and
a control and reporting module, in communication with said drive-thru timer, wherein said control and reporting module is operable to receive said vehicle event information from said drive-thru timer, and wherein said control and reporting module is operable to receive at least one operator configurable message for subsequent display on said at least one display.

2. The system of claim 1, wherein said at least one operator configurable message is an operator configurable text message.

3. The system of claim 1, wherein said control and reporting module is further operable to calculate, using said vehicle event information, vehicle timing data comprising the elapsed time the vehicle remains in said drive-thru.

4. The system of claim 1, wherein said drive-thru timer receives said at least one operator configurable message from said control and reporting module, and wherein said drive-thru timer displays said operator configurable message to said operator via said at least one display.

5. The system of claim 1, wherein said control and reporting module is operable to receive at least one operator-configurable timing goal.

6. The system of claim 5, wherein said drive-thru timer receives said at least one operator-configurable goal from said control and reporting module.

7. The system of claim 5, wherein said drive-thru timer displays one of said at least one operator-configurable messages based on the at least one operator-configurable timing goal.

8. The system of claim 1, wherein said at least one display comprises at least one display operable to display messages in at least two colors.

9. The system of claim 1, wherein said control and reporting module comprises a network interface, and wherein said control and reporting module is remotely accessible via said network interface.

10. The system of claim 9, wherein said control and reporting module is in electrical communication with a point of sale (POS) terminal.

11. The system of claim 1, wherein said control and reporting module resides outside of said drive-thru timer.

12. A method for displaying operator-configurable messages in a drive-thru system, comprising:
providing a drive-thru timer, in communication with at least one vehicle detection device, wherein said drive-thru timer collects vehicle event information based in part on the location of a vehicle in a drive-thru; and
displaying on at least one display, an operator-configurable message based at least in part on said vehicle event information.

13. The method of claim 12, wherein the step of displaying said operator-configurable message comprises displaying an operator-configurable message consisting of letters.

14. The method of claim 12, further comprising providing a control and reporting module, wherein said control and reporting module receives said vehicle event information from said drive-thru timer, and wherein said control and reporting module receives the operator-configurable message for display on said at least one display.

15. The method of claim 14, further comprising the step of calculating vehicle timing data based on said vehicle event information, said vehicle timing data comprising the elapsed time the vehicle remains in said drive-thru.

16. The method of claim 14, wherein said control and reporting module receives at least one operator-configurable timing goal.

17. The method of claim 16, wherein said drive-thru timer receives said at least one operator-configurable goal from said control and reporting module and therein the step of displaying on at least one display, an operator-configurable message comprises displaying, on the at least one display, based at least in part on said vehicle event information and on the at least one operator-configurable timing goal.

18. The method of claim 14, wherein displaying on at least one display an operator-configurable message comprises displaying said at least one operator-configurable message in at least two colors.

19. The method of claim 14, further comprising accessing said control and reporting module remotely.

20. The method of claim 19, wherein said control and reporting module communicates with a point of sale (POS) terminal.
